(19) United States
(12) Patent Application Publication
(10) Pub. No.: US 2012/0158647 A1
(43) Pub. Date: Jun. 21, 2012

(54) Block Compression in File System

(75) Inventors: Krishna YADAPPANAVAR, Los Gatos, CA (US); Satyam B. VAGHANI, San Jose, CA (US)

(73) Assignee: VMware, Inc., Palo Alto, CA (US)

(21) Appl. No.: 12/973,781

(22) Filed: Dec. 20, 2010

(51) Int. Cl. G06F 17/30

(52) U.S. Cl. 707/609; 707/E17.005

(57) ABSTRACT

Individual blocks of data associated with a file are compressed into sub-blocks according to a compression type. For block compression type, an entire block of data is compressed and stored in the sub-block. For substream compression type, a block of data is first divided into multiple substreams that are each individually compressed and stored within the sub-block.

### BACKGROUND

In recent computer systems, the amount of data stored within file systems is constantly increasing. For example, in a virtual machine based system, storing virtual machine images in a file system typically involves storing file sizes of 20 GB or more. Storing these files requires large storage subsystems, which are both expensive and inefficient to maintain. To reduce the storage footprint of a large file, prior art file systems perform, when possible, compression operations on the entire file. One drawback to this compression technique is that when any input/output (IO) operation is to be performed on a small portion of the file, the entire file is decompressed and then recompressed. Because the IO penalty and the processing penalty of a compression operation is proportional to the amount of data being compressed or decompressed, decompression and recompression of an entire file to access only a small portion of the file is extremely inefficient.

### SUMMARY

One or more embodiments of the present invention provide techniques for compressing individual blocks of data associated with a file into sub-blocks according to a compression type. For block compression type, an entire block of data is compressed and stored in the sub-block. For substream compression type, a block of data is first divided into multiple substreams that are each individually compressed and stored within the sub-block.

A method of storing compressed data within a file system, according to an embodiment of the invention, includes the steps of identifying a block of data within the file system that should be compressed, compressing the block of data according to a compression type, allocating a sub-block within the file system for storing the compressed block of data, and storing the compressed block of data within the sub-block.

A file inode associated with a file within a file system, according to an embodiment of the invention, comprises one or more file attributes, a set of block references, where each block reference is associated with a different block within a data storage unit (DSU) that stores a portion of the file, and a set of sub-block references, where each sub-block reference is associated with a different sub-block within the DSU that stores a portion of the file.

### BRIEF DESCRIPTION OF THE DRAWINGS

FIG. 1 illustrates a computer system configuration utilizing a file system in which one or more embodiments of the present invention may be implemented.

FIG. 2A illustrates a computer system in which one or more embodiments of the present invention may be implemented.

FIG. 2B illustrates a virtual machine based system in which one or more embodiments of the present invention may be implemented.

FIG. 3 illustrates a configuration for storing data within the file system, according to one or more embodiments of the present invention.

FIG. 4A illustrates a more detailed view of a file inode of FIG. 3, according to one or more embodiments of the present invention.

FIG. 4B illustrates two sub-blocks storing compressed data according to two different storage mechanisms, according to one or more embodiments of the present invention.

FIG. 5 is a flow diagram of method steps for performing compression operations on a block, according to one or more embodiments of the present invention.

FIG. 6 is a flow diagram of method steps for performing compression operations associated with the substream compression type on a block, according to one or more embodiments of the present invention.

FIG. 7 is a flow diagram of method steps for performing a read operation when data is compressed according to a block compression type, according to one or more embodiments of the present invention.

FIG. 8 is a flow diagram of method steps for performing a read operation when data is compressed according to a substream compression type, according to one or more embodiments of the present invention.

FIGS. 9A and 9B set forth a flow diagram of method steps for performing a write operation when data is compressed according to a block compression type, according to one or more embodiments of the present invention.

FIGS. 10A and 10B set forth a flow diagram of method steps for performing a write operation when data is compressed according to a block compression type, according to one or more embodiments of the present invention.

### DETAILED DESCRIPTION

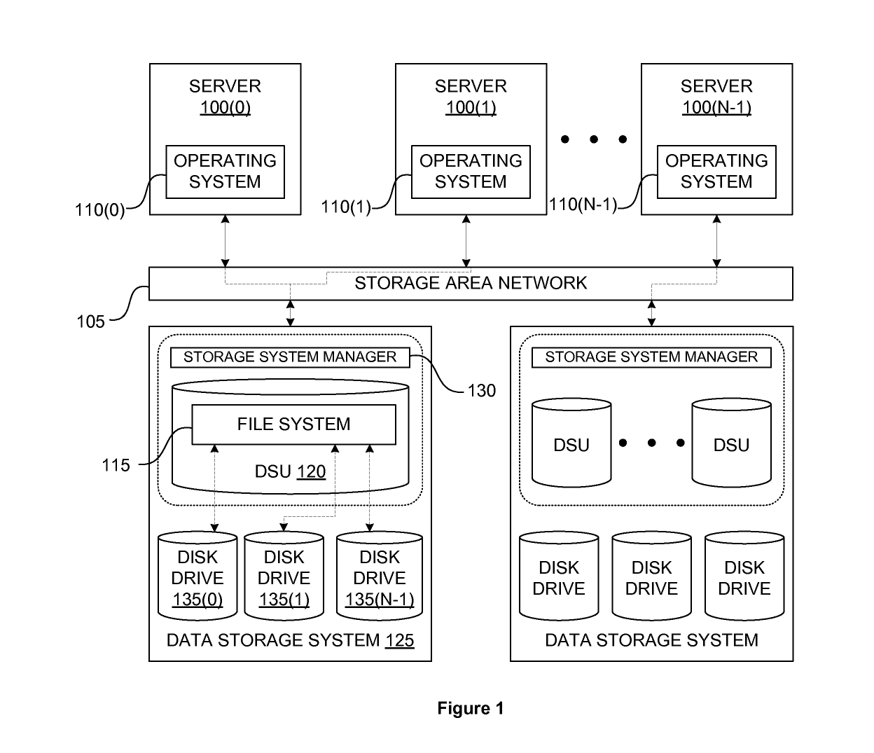

FIG. 1 illustrates a computer system configuration utilizing a file system, in which one or more embodiments of the present invention may be implemented. A clustered file system is illustrated in FIG. 1, but it should be recognized that embodiments of the present invention are applicable to non-clustered file systems as well. The computer system configuration of FIG. 1 includes multiple servers 100(0) to 100(N−1), each of which is connected to storage area network (SAN) 105. Operating systems 110(0) and 110(1) on servers 100(0) and 100(1) interact with a file system 115 that resides on a data storage unit (DSU) 120 accessible through SAN 105. In particular, DSU 120 is a logical unit (LUN) of a data storage system 125 (e.g., disk array) connected to SAN 105. While DSU 120 is exposed to operating systems 110(0) and 110(1) by storage system manager 130 (e.g., disk controller) as a contiguous logical storage space, the actual physical data blocks upon which file system 115 may be stored is dispersed across the various physical disk drives 135(0) to 135(N−1) of data storage system 125.

File system 115 contains a plurality of files of various types, typically organized into one or more directories. File system 115 further includes metadata data structures that store information about file system 115, such as block bitmaps that indicate which data blocks in file system 115 remain available for use, along with other metadata data structures such as inodes for directories and files in file system 115.

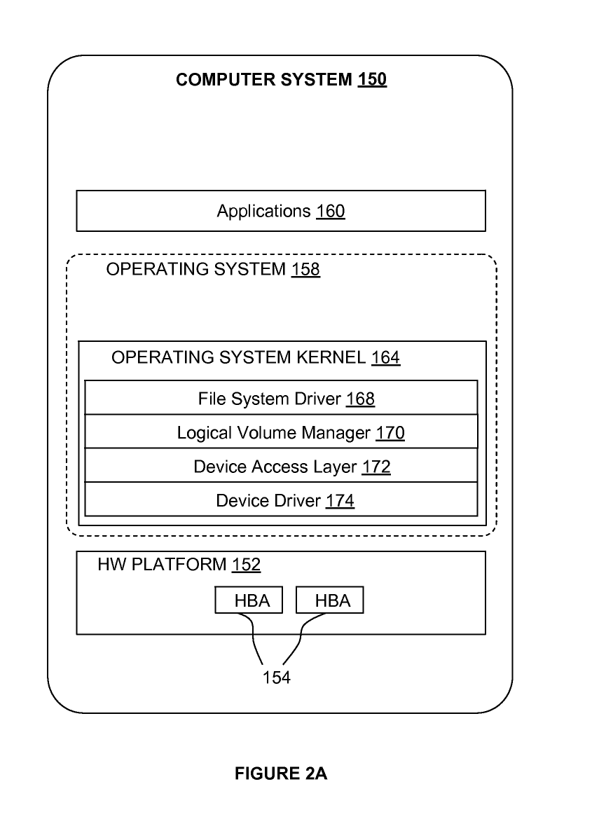

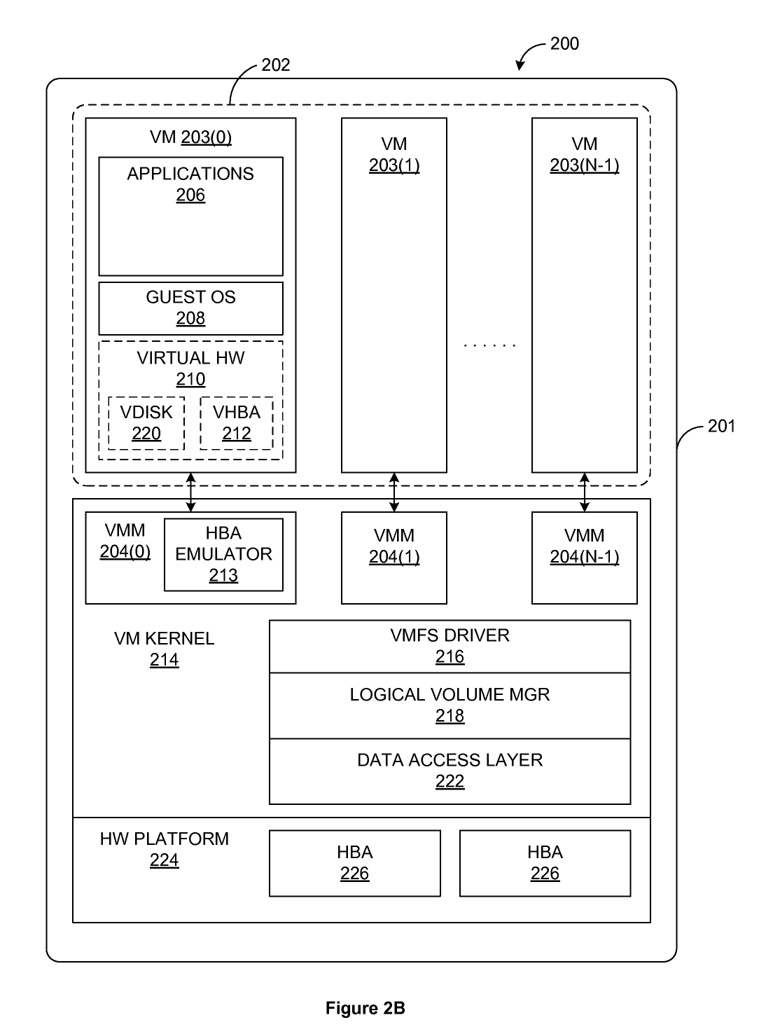

FIG. 2A illustrates a computer system 150 which generally corresponds to one of computer system servers 100. Computer system 150 may be constructed on a conventional, typically server-class, hardware platform 152, and includes host bus adapters (HBAs) 154 that enable computer system 100 to connect to data storage system 125. An operating system 158 is installed on top of hardware platform 152 and it supports execution of applications 160. Operating system kernel 164 provides process, memory and device management to enable various executing applications 160 to share limited resources of computer system 150. For example, file system calls initiated by applications 160 are routed to a file system driver 168. File system driver 168, in turn, converts the file system operations to LUN block operations, and provides the LUN block operations to a logical volume manager 170. File system driver 168, in general, manages creation, use, and deletion of files stored on data storage system 125 through the LUN abstraction discussed previously. Logical volume manager 170 translates the volume block operations for execution by data storage system 125, and issues raw SCSI operations (or operations from any other appropriate hardware connection interface standard protocol known to those with ordinary skill in the art, including IDE, ATA, and ATAPI) to a device access layer 172 based on the LUN block operations. Device access layer 172 discovers data storage system 125, and applies command queuing and scheduling policies to the raw SCSI operations. Device driver 174 understands the input/output interface of HBAs 154 interfacing with data storage system 125, and sends the raw SCSI operations from device access layer 172 to HBAs 154 to be forwarded to data storage system 125.

FIG. 2B illustrates a virtual machine based computer system 200, according to an embodiment. A computer system 201, generally corresponding to one of servers 100, is constructed on a conventional, typically server-class hardware platform 224, including, for example, host bus adapters (HBAs) 226 that network computer system 201 to remote data storage systems, in addition to conventional platform processor, memory, and other standard peripheral components (not separately shown). Hardware platform 224 is used to execute a hypervisor 214 (also referred to as virtualization software) supporting a virtual machine execution space 202 within which virtual machines (VMs) 203 can be instantiated and executed. For example, in one embodiment, hypervisor 214 may correspond to the vSphere product (and related utilities) developed and distributed by VMware, Inc., Palo Alto, Calif. although it should be recognized that vSphere is not required in the practice of the teachings herein.

Hypervisor 214 provides the services and support that enable concurrent execution of virtual machines 203. Each virtual machine 203 supports the execution of a guest operating system 208, which, in turn, supports the execution of applications 206. Examples of guest operating system 208 include Microsoft® Windows®, the Linux® operating system, and NetWare®-based operating systems, although it should be recognized that any other operating system may be used in embodiments. Guest operating system 208 includes a native or guest file system, such as, for example, an NTFS or ext3FS type file system. The guest file system may utilize a host bus adapter driver (not shown) in guest operating system 208 to interact with a host bus adapter emulator 213 in a virtual machine monitor (VMM) component 204 of hypervisor 214. Conceptually, this interaction provides guest operating system 208 (and the guest file system) with the perception that it is interacting with actual hardware.

FIG. 2B also depicts a virtual hardware platform 210 as a conceptual layer in virtual machine 203(0) that includes virtual devices, such as virtual host bus adapter (HBA) 212 and virtual disk 220, which itself may be accessed by guest operating system 208 through virtual HBA 212. In one embodiment, the perception of a virtual machine that includes such virtual devices is effectuated through the interaction of device driver components in guest operating system 208 with device emulation components (such as host bus adapter emulator 213) in VMM 204(0) (and other components in hypervisor 214).

File system calls initiated by guest operating system 208 to perform file system-related data transfer and control operations are processed and passed to virtual machine monitor (VMM) components 204 and other components of hypervisor 214 that implement the virtual system support necessary to coordinate operation with hardware platform 224. For example, HBA emulator 213 functionally enables data transfer and control operations to be ultimately passed to host bus adapters 226. File system calls for performing data transfer and control operations generated, for example, by one of applications 206 are translated and passed to a virtual machine file system (VMFS) driver 216 that manages access to files (e.g., virtual disks, etc.) stored in data storage systems (such as data storage system 125) that may be accessed by any of virtual machines 203. In one embodiment, access to DSU 120 is managed by VMFS driver 216 and shared file system 115 for LUN 120 is a virtual machine file system (VMFS) that imposes an organization of the files and directories stored in DSU 120, in a manner understood by VMFS driver 216. For example, guest operating system 208 receives file system calls and performs corresponding command and data transfer operations against virtual disks, such as virtual SCSI devices accessible through HBA emulator 213, that are visible to guest operating system 208. Each such virtual disk may be maintained as a file or set of files stored on VMFS, for example, in DSU 120. The file or set of files may be generally referred to herein as a virtual disk and, in one embodiment, complies with virtual machine disk format specifications promulgated by VMware (e.g., sometimes referred to as a vmdk files). File system calls received by guest operating system 208 are translated to instructions applicable to particular file in a virtual disk visible to guest operating system 208 (e.g., data block-level instructions for 4 KB data blocks of the virtual disk, etc.) to instructions applicable to a corresponding vmdk file in VMFS (e.g., virtual machine file system data block-level instructions for 1 MB data blocks of the virtual disk) and ultimately to instructions applicable to a DSU exposed by data storage unit 125 that stores the VMFS (e.g., SCSI data sector-level commands). Such translations are performed through a number of component layers of an “IO stack,” beginning at guest operating system 208 (which receives the file system calls from applications 206), through host bus emulator 213, VMFS driver 216, a logical volume manager 218 which assists VMFS driver 216 with mapping files stored in VMFS with the DSUs exposed by data storage systems networked through SAN 105, a data access layer 222, including device drivers, and host bus adapters 226 (which, e.g., issues SCSI commands to data storage system 125 to access LUN 120).

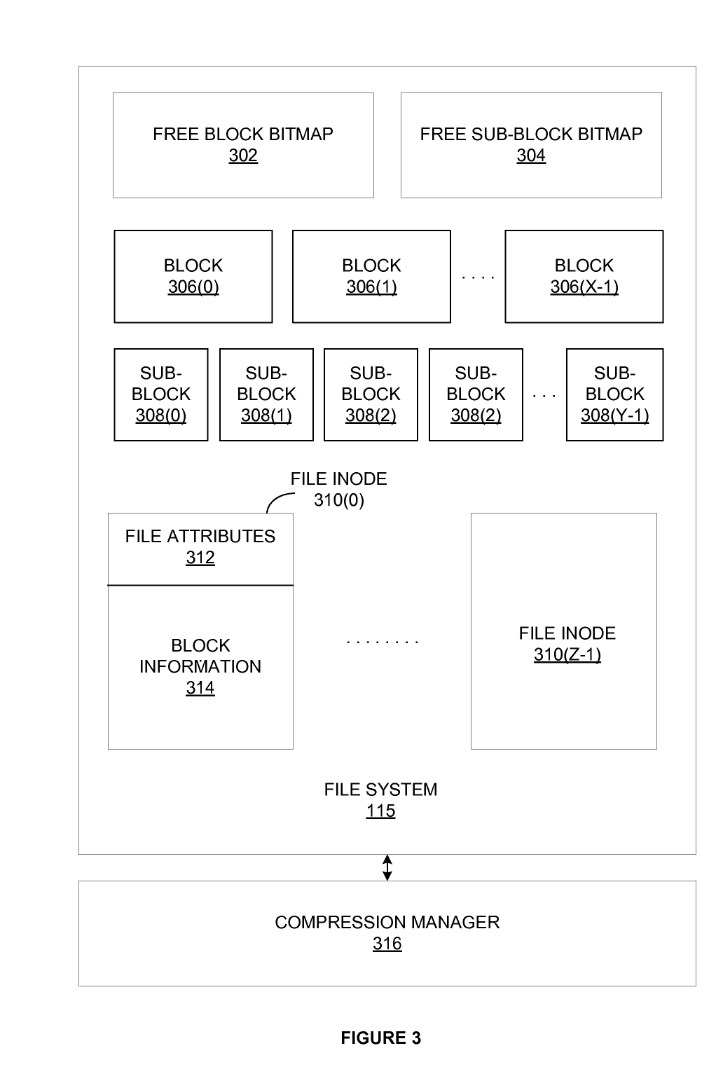

FIG. 3 illustrates a configuration for storing data within the file system, according to one or more embodiments of the present invention. As shown, file system 115 includes a free block bitmap 302, a free sub-block bitmap 304, blocks 306, sub-blocks 308 and file inodes 310.

Data within file system 115 is stored within blocks 306 and sub-blocks 308 of file system 115, which are pre-defined units of storage. More specifically, each of blocks 306 is a configurable fixed size and each of sub-blocks 308 is a different configurable fixed size, where the size of a block 306 is larger than the size of a sub-block 308. In one embodiment, the size of a block 306 can range between 1 MB and 8 MB, and the size of a sub-block 308 can range between 8 KB and 64 KB.

In addition, each block 306 within file system 115 is associated with a specific bit within free block bitmap 302. Each bit within free block bitmap 302 indicates whether the associated block 306 is allocated or unallocated. Similarly, each sub-block 308 within file system 115 is associated with a specific bit within free sub-block bitmap 304. Each bit within free sub-block bitmap 304 indicates whether the associated sub-block 308 is allocated or unallocated.

Data associated with a particular file within file system 115 is stored in a series of blocks 306 and/or a series of sub-blocks 308. A file inode 310 associated with the file includes attributes of the file as well as the addresses of blocks 306 and/or sub-blocks 308 that store the data associated with the file. During a read or write operation (referred to herein as an “IO operation”) being performed on a portion of a particular file, file inode 310 associated with the file is accessed to identify the specific blocks 306 and/or sub-blocks 308 that store the data associated with that portion of the file. The identification process typically involves an address resolution operation performed via a block resolution function. The IO operation is then performed on the data stored within the specific block(s) 306 and/or sub-block(s) 308 associated with the IO operation.

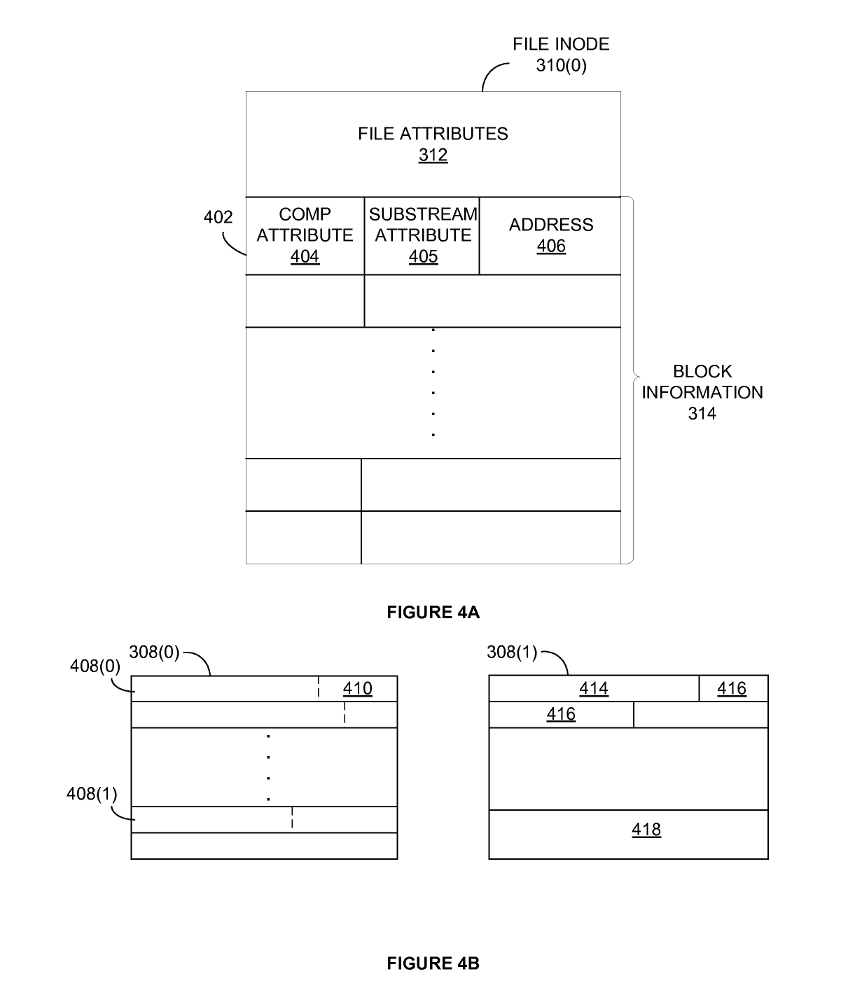

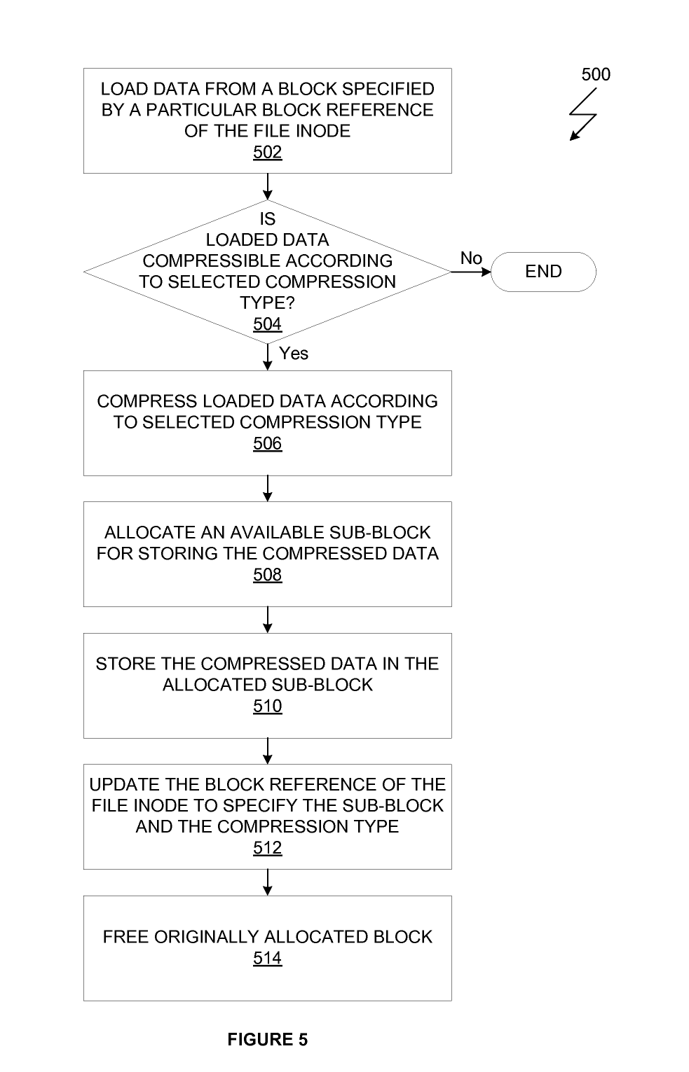

FIG. 4A illustrates a more detailed view of file inode 310(0) of FIG. 3. For the purposes of discussion, file inode 310(0) is associated with File A. File attributes 312 stores attributes associated with File A, such as the size of File A, the size and the number of blocks 306 and sub-blocks 308 that store data associated with File A, etc. In addition, the information associated with the different blocks 306 and sub-blocks 308 that store data associated with File A is stored in block information 314. Block information 314 includes a set of block references 402, where each non-empty block reference 402 corresponds to a particular portion of File A and includes address portion 406 of the particular block 306 or the particular sub-block 308 storing that portion of File A. Each non-empty block reference 402 also includes a compression attribute 404 that indicates the type of compression, if any, that is performed on the portion of File A stored in the corresponding block 306 or sub-block 308. The different types of compression as well as the process of accessing compressed data are described in greater detail with respect to FIGS. 5-10.

In one embodiment, the data in a block 306 is compressed according to a “block compression type,” where a compression algorithm is applied to the entire loaded data and the compressed data is stored in a specific sub-block 308. In an alternative embodiment, the data in a block 306 is compressed according to a “substream compression type,” where the loaded data is divided into a fixed number of substreams and each substream is independently compressed. Each compressed substream is stored in the same sub-block 308. In such an embodiment, the compressed substreams can be stored according to two different storage mechanisms, as shown in FIG. 4B. Sub-block 308(0) stores compressed substreams, such as substreams 408(0) and 408(1), as fixed-size substreams. If a compressed substream is smaller than the fixed size, the substream is padded, such as padding 410 added to substream 408(0). Alternately, sub-block 308(1) stores compressed substreams having variable sizes, such as substream 414 and substream 416. These substreams are stored in a continuous fashion within sub-block 308(1), and a dictionary 418 stores the offset within the sub-block where each substream begins.

Referring back now to FIG. 3, compression manager 316 performs compression operations on different blocks 306 associated with files within file system 115 to make the storage of data more space-efficient. Compression manager 316 described herein can be implemented within VM kernel 214 or within operating system kernel 164. The compression operations can be performed by compression manager 316 periodically at pre-determined time intervals and/or after file creation. A particular file or a particular block 306 storing data associated with a file may be selected for compression by compression manager 316 based on different heuristics. The heuristics monitored by compression manager 316 include, but are not limited to, the frequency of block usage, input/output pattern to blocks and a set of cold blocks.

In one embodiment, compression manager 316 implements a hot/cold algorithm when determining which blocks 306 should be compressed. More specifically, compression manager 316 monitors the number and the frequency of IO operations performed on each of blocks 306 using a histogram, a least-recently-used list or any other technically feasible data structure. Blocks 306 that are accessed less frequently are selected for compression by compression manager 316 over blocks 306 that are accessed more frequently. In this fashion, blocks 306 that are accessed more frequently do not have to be decompressed (in the case of reads from blocks) and recompressed (in the case of writes to blocks) each time an IO operation is to be performed on those blocks 306.

When a block 306 storing data associated with a particular file is selected for compression, compression manager 316 performs the steps described below in conjunction with FIG. 5.

FIG. 5 is a flow diagram of method steps for performing compression operations on a block 306, according to one or more embodiments of the present invention. Although the method steps are described in conjunction with the systems for FIGS. 1-4, it should be recognized that any system configured to perform the method steps is within the scope of the invention.

Method 500 begins at step 502, where compression manager 316 loads the data associated with a portion of a particular file and stored within block 306 selected for compression. Compression manager 316 identifies the address of the selected block 306 via address portion 406 included within a corresponding block reference 402 of file inode 310 associated with the particular file. Again, a particular block 306 storing data associated with a file may be selected for compression by compression manager 316 based on different heuristics. The heuristics monitored by compression manager 316 include, but are not limited to, the frequency of block usage, input/output pattern to blocks and a set of cold blocks

At step 504, compression manager 316 determines whether the data loaded from block 306 selected for compression is compressible based on the selected compression type. Again, in one embodiment, the data is compressed according to a “block compression type,” where a compression algorithm is applied to the entire loaded data. In such an embodiment, compressibility is determined based on whether the entire loaded data, when compressed, can fit into a sub-block 308. Again, in an alternative embodiment, the data is compressed according to a “substream compression type,” where the loaded data is divided into a fixed number of substreams and each substream is independently compressed. In such an embodiment, compressibility is determined based on the compressed substreams as will be further described below. Any other technically feasible compression types and compressibility criteria are within the scope of this invention. The compressibility of data is primarily determined based on whether the loaded data, when compressed according to the selected compression type, fits into a sub-block 308. In one embodiment, compression manager 316 attempts to attempt to utilize multiple types of “compression types” sequentially to successfully compress data in a data block. For example, compression manager 316 first attempts to compress block 306 according to the “substream compression type,” and if block 306 is not compressible according to the “substream compression type,” then compression manager 316 attempts to compress block 306 according to the “block compression type.”

If, at step 504, compression manager 316 determines that the data loaded from block 306 selected for compression is not compressible, then method 500 ends. In this scenario, the data loaded from block 306 cannot be compressed according to the selected compression type, and compression manager 316 may attempt to compress the data within block 306 according to a different compression type. For example, compression manager 316 may attempt to compress the data within block 306 according to the block compression type if the data is not compressible according to the substream compression type. For a particular file, some blocks 306 associated with the file may be compressible while others may not. In such scenarios, portions of the file may be stored in a compressed format, while other portions remain uncompressed.

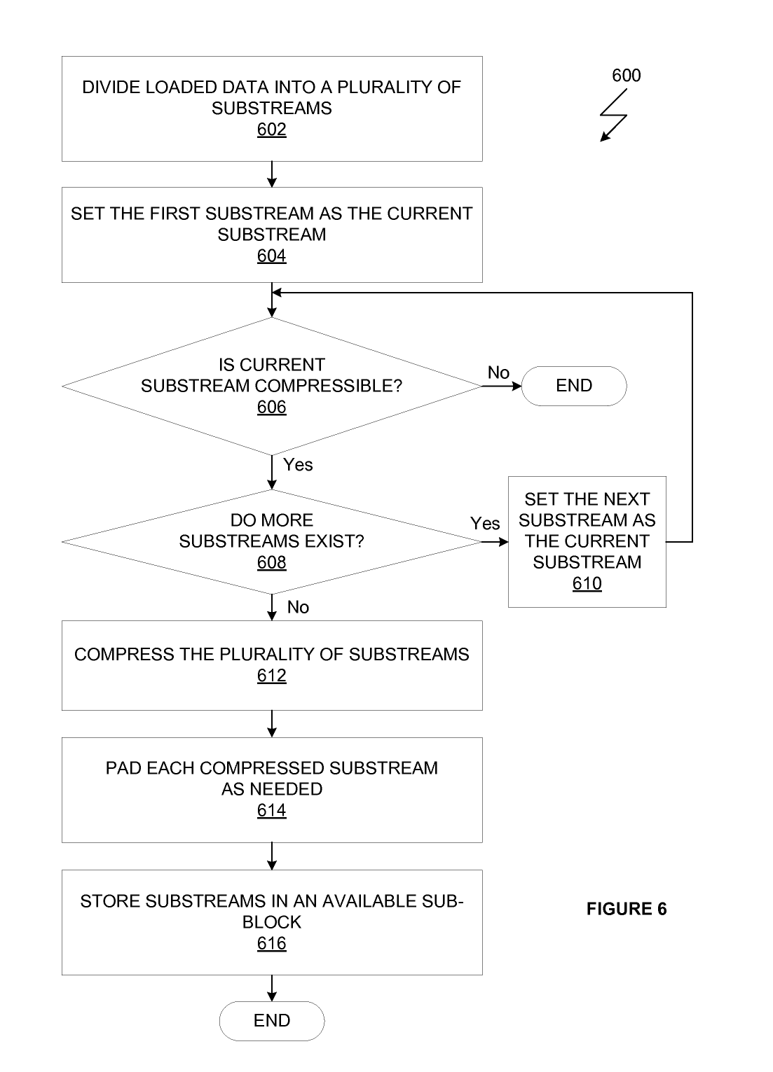

If, however, at step 504, compression manager 316 determines that the data loaded from block 306 selected for compression is compressible, then method 500 proceeds to step 506. At step 506, compression manager 316 compresses the data according to the selected compression type. In the case of the block compression type, compression manager 316 applies a compression algorithm on the entire loaded data to generate the compressed data. In the case of the substream compression type, the loaded data is first divided into a fixed number of substreams and each substream is independently compressed. When compressing according to the substream compression type, the operations performed by compression manager 316 at steps 504 and 506 are described in greater detail below in conjunction with FIG. 6.

At step 508, compression manager 316 identifies an available sub-block 308 via the free sub-block bitmap 304 and allocates the available sub-block 308 for storing the compressed data. At step 510, compression manager 316 stores the compressed data in the allocated sub-block 308. At step 512, compression manager 316 updates the specific block reference 402 associated with the compressed data to include the address of sub-block 308 in address portion 406 and the compression type of the compressed data in compression attribute 404. At step 514, compression manager 316 updates free block bitmap 302 to indicate that block 306 that was selected for compression is free and available for reallocation.

FIG. 6 is a flow diagram of method steps for performing compression operations associated with the substream compression type on a block 306, according to one or more embodiments of the present invention. Although the method steps are described in conjunction with the systems for FIGS. 1-4, it should be recognized that any system configured to perform the method steps is within the scope of the invention.

Method 600 begins at step 602, where compression manager 316 divides the data loaded from a block 306 selected for compression into a pre-determined number of fixed-sized substreams. At step 604, compression manager 316 sets the first substream as the current substream.

At step 606, compression manager 316 determines whether the current substream is compressible. The compressibility of a substream is determined based on whether the substream, when compressed using a compression algorithm, fits into a pre-determined portion of a sub-block 308. If compression manager 316 determines that the current substream is not compressible, then method 600 ends. In such a manner, the substream compression type is performed on a block 306 only if each substream of block 306 is compressible.

If, however, compression manager 316 determines that the current substream is compressible, then the method proceeds to step 608, compression manager 316 determines whether more substreams exist. If more substreams exist, then at step 620 compression manager 316 sets the next substream as the current substream and method 600 returns back to step 606, previously described herein. If more substreams do not exist, then method 600 proceeds to step 612. In such a manner, the substream compression type is performed on a block 306 only if each substream of block 306 is compressible.

At step 612, each substream in the plurality of substreams is compressed via the compression algorithm. At step 614, compression manager 316 pads each compressed substream, as needed, such that the size of the compressed sub stream is equal to the corresponding pre-determined portion of a sub-block 308. More specifically, when the size of the compressed substream is smaller than the size of the corresponding pre-determined portion, compression manager 316 appends padding bits to the end of the compressed substream to fill the corresponding pre-determined portion.

At step 616, compression manager 316 stores the compressed substream data into the pre-determined portion of an available sub-block 308, as previously described herein in conjunction with steps 508-512 of FIG. 5. More specifically, in this case, at step 512, not only does compression manager 316 update the address of sub-block 308 in address portion 406 and the compression type of the compressed data in compression attribute 404, compression manager 316 also updates substream attribute 405 of the specific block reference 402 to indicates the size of the fixed size of the different compressed and padded substreams.

In one embodiment, the padding operation described at step 614 is not performed and a dictionary that identifies the start offset of each compressed substream within sub-block 308 is generated. The dictionary is appended to sub-block 308 and updated if the size of a compressed substreams changes. In such an embodiment, the offset of the dictionary appended to sub-block 308 is stored in substream attribute 405 of the specific block reference 402.

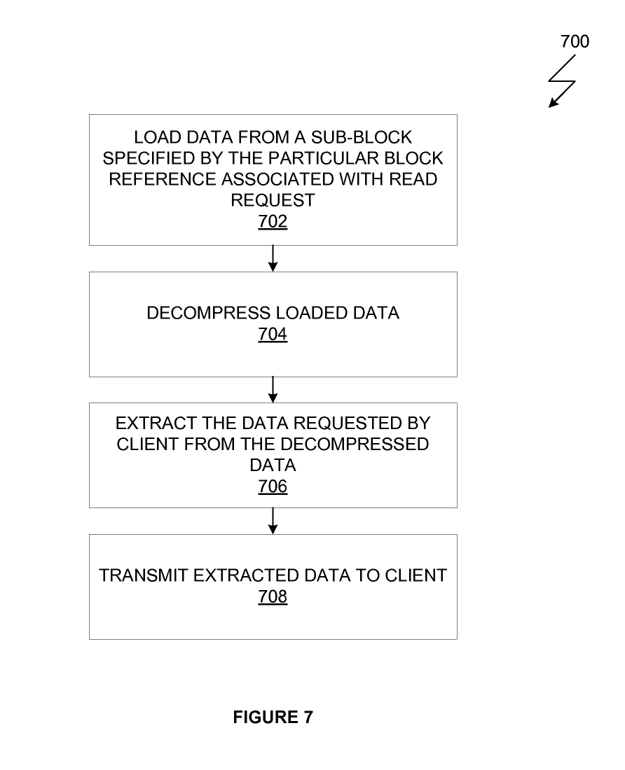

IO operations on files that include blocks and sub-blocks that are compressed in the manner described above will now be described in the context of virtual machine system 200 of FIG. 2B in conjunction with FIGS. 7 through 10B. As previously described herein, VMFS 216 receives an IO request associated with a portion of a particular file from a VM 203 (referred to herein as “the client”). As an example, such a file could represent the virtual hard disk for VM 203. VMFS 216, in response to the IO request, loads file inode 310 of the file to identify block reference 402 corresponding to the portion of the file. From the identified block reference 402, the address of block 306 or sub-block 308 that stores the data associated with the portion of the file is determined. In addition, the compression attribute is read from the identified block reference 402 to determine the type of compression, if any, that was performed on the portion of the file. If no compression was performed, then the data is stored within a block 306. In such a scenario, the data is loaded from block 306, and the IO request is serviced.

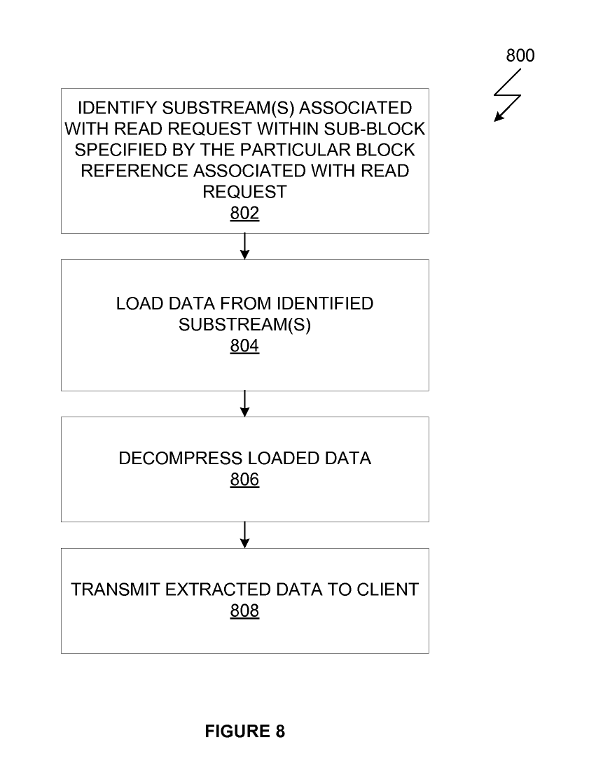

If, however, compression was performed, then the data is stored within a sub-block 308. In such a scenario, the compression attribute also indicates the type of compression that was performed on the data. When the IO request is a read request and the compression attribute indicates a block compression type, the steps described in FIG. 7 are performed by VMFS 216 to service the read request. When the IO request is a read request and the compression attribute indicates a substream compression type, the steps described in FIG. 8 are performed by VMFS 216 to service the read request.

FIG. 7 is a flow diagram of method steps for performing a read operation when data is compressed according to a block compression type, according to one or more embodiments of the present invention. Although the method steps are described in conjunction with the systems for FIGS. 1-4, it should be recognized that any system configured to perform the method steps is within the scope of the invention.

Method 700 begins at step 702, where VMFS 216 loads the data from sub-block 308 associated with the address included in the identified block reference 402. At step 704, VMFS 216 decompresses the loaded data according to a pre-determined decompression algorithm. At step 706, VMFS 216 extracts a portion of the decompressed data associated with the read request from the decompressed data. At step 708, the extracted data is transmitted to the client, and the read request is serviced.

FIG. 8 is a flow diagram of method steps for performing a read operation when data is compressed according to a substream compression type, according to one or more embodiments of the present invention. Although the method steps are described in conjunction with the systems for FIGS. 1-4, it should be recognized that any system configured to perform the method steps is within the scope of the invention.

The method 800 begins at step 802, where VMFS 216 identifies the substream(s) within sub-block 308 that include the requested data based on the address included within the read request. VMFS 216 resolves the address included in the read request to identify sub-block 308 from which the data associated with the read request should be read. Since, generally, more than one substream is stored in sub-block 308, VMFS 216 then determines the sub-stream(s) within sub-block 308 corresponding to the resolved address. In the embodiment where the each compressed substream is the same fixed size, VMFS 216 determines based on the resolved address and the size indicated by substream attribute 405, the specific offset within sub-block 308 that would store the start of the compressed substream(s) corresponding to the read request. In the embodiment where a dictionary is appended to a sub-block 308 that includes the start offsets of the different substreams within sub-block 308, VMFS 216 determines the location of the identified substreams by reading the dictionary.

At step 804, VMFS 216 loads the data from the identified substream(s) within sub-block 308. At step 806, VMFS 216 decompresses the loaded data according to a pre-determined decompression algorithm. At step 808, VMFS 216 extracts a portion of the decompressed data associated with the read request from the decompressed data. At step 810, the extracted data is transmitted to the client, and the read request is serviced.

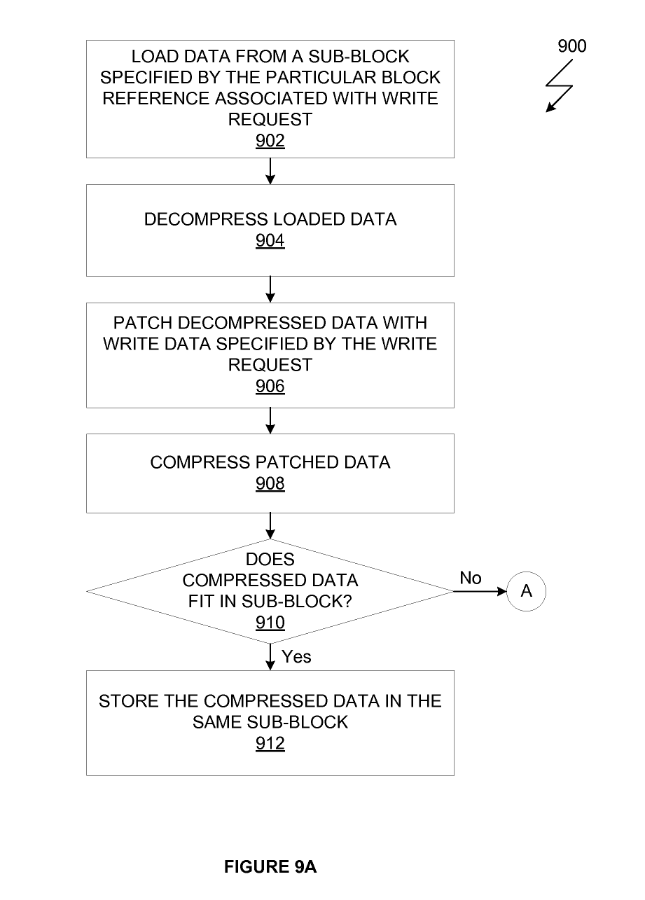

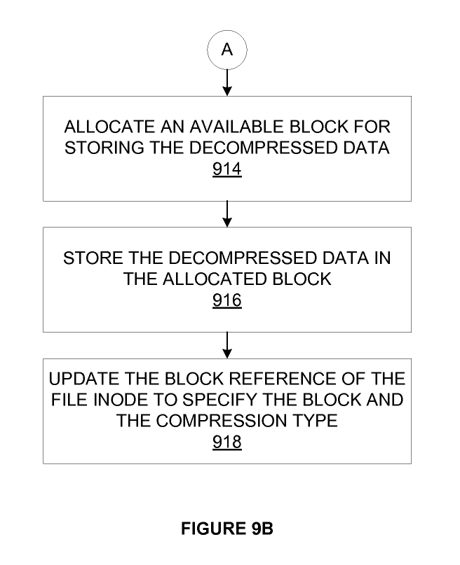

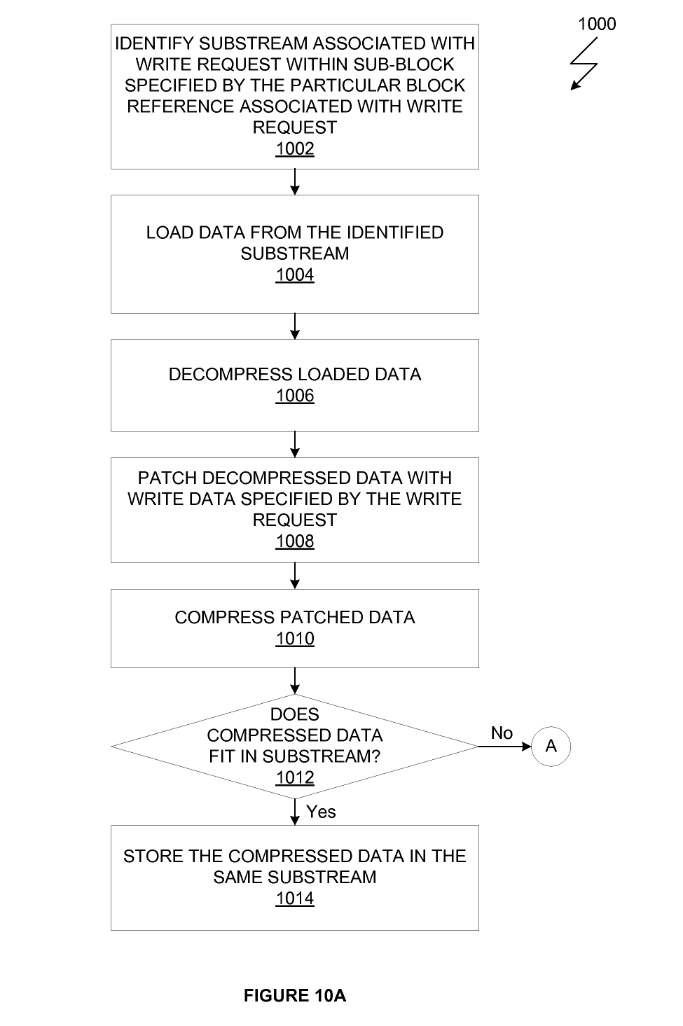

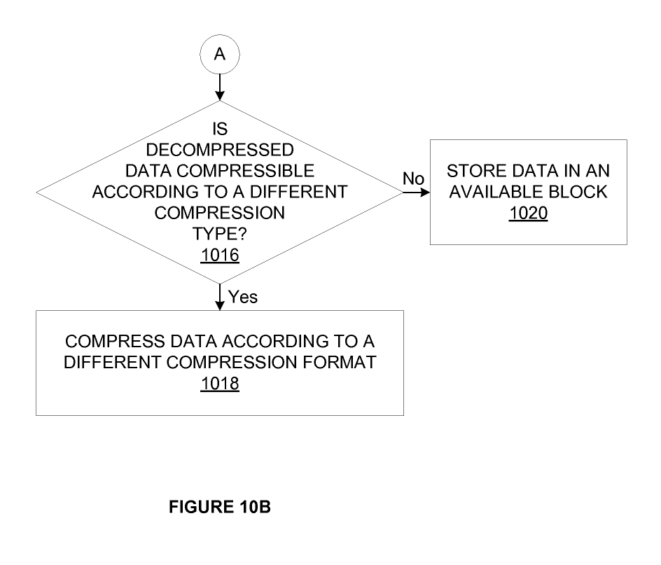

When the IO request is a write request and the compression attribute indicates a block compression type, the steps described in FIG. 9 are performed by VMFS 216 to service the write request. When the IO request is a write request and the compression attribute indicates a substream compression type, the steps described in FIG. 10 are performed by VMFS 216 to service the write request.

FIGS. 9A and 9B set forth a flow diagram of method steps for performing a write operation when data is compressed according to a block compression type, according to one or more embodiments of the present invention. Although the method steps are described in conjunction with the systems for FIGS. 1-4, it should be recognized that any system configured to perform the method steps is within the scope of the invention.

Method 900 begins at step 902, where VMFS 216 loads the data from sub-block 308 associated with the address included in block reference 402 corresponding to the write request. At step 904, VMFS 216 decompresses the loaded data according to a pre-determined decompression algorithm. At step 906, VMFS 216 patches the decompressed data with the write data included in the write request and received from the client. At step 908, VMFS 216 re-compresses the patched data according to the block compression type.

At step 910, VMFS 216 determines whether the compressed data fits into sub-block 308 from which the data was loaded at step 902. If the compressed data fits into sub-block 308, then, at step 912, VMFS 216 stores the compressed data in sub-block 308 and method 900 ends. In one embodiment, at step 912, the compressed data is first stored in a different sub-block and then copied to sub-block 308 to avoid in-place data corruption. In another embodiment, at step 912, to avoid in-place data corruption, the data currently stored in sub-block 308 is stored in a journaling region and then the compressed data is stored in sub-block 308. over-written.

At step 910, if the compressed data does not fit into sub-block 308, then method 900 proceeds to step 914. At step 914, VMFS 216 identifies an available block 306 via free block bitmap 302 and allocates the available block 306 for storing data that was decompressed at step 904. At step 916, VMFS 216 stores the decompressed data in the allocated block 306. At step 918, VMFS 216 updates the specific block reference 402 to include the address of block 306 in address portion 406 and a compression type indicating that the data stored in block 306 is not compressed in compression attribute 404. VMFS 216 also updates free sub-block bitmap 304 to indicate that sub-block 308 from which the data was loaded at step 902 is free and available for reallocation.

FIGS. 10A and 10B set forth a flow diagram of method steps for performing a write operation when data is compressed according to a block compression type, according to one or more embodiments of the present invention. Although the method steps are described in conjunction with the systems for FIGS. 1-4, it should be recognized that any system configured to perform the method steps is within the scope of the invention.

Method 1000 begins at step 1002, where VMFS 216 identifies the substream within sub-block 308 to which data associated with the write request should be written. In this step, VMFS 216 first resolves the address included in the write and then identifies the sub-streams corresponding to the resolved address within sub-block 308 associated with the write request. Since, generally, more than one substream is stored in sub-block 308, VMFS 216 then determines the sub-stream(s) within sub-block 308 corresponding to the resolved address. In the embodiment where the each compressed substream is the same fixed size, VMFS 216 determines based on the resolved address and the size indicated by substream attribute 405, the specific offset within sub-block 308 that would store the start of the compressed substream(s) corresponding to the read request. In the embodiment where a dictionary is appended to a sub-block 308 that includes the start offsets of the different substreams within sub-block 308, VMFS 216 determines the location of the identified substreams by reading the dictionary.

At step 1004, VMFS 216 loads the data from the identified substream within sub-block 308. At step 1006, VMFS 216 decompresses the loaded data according to a pre-determined decompression algorithm. At step 1008, VMFS 216 patches the decompressed data with the write data included in the write request and received from the client. At step 1010, VMFS 216 re-compresses the patched data according to the substream compression type.

At step 1012, VMFS 216 determines whether the compressed data fits into the substream within sub-block 308 from which the data was loaded at step 1002. If the compressed data fits into the substream within sub-block 308, then, at step 1014, VMFS 216 stores the compressed data in the substream and method 1000 ends. If, however, the compressed data does not fit into sub-block 308, then method 1000 proceeds to step 1016.

At step 1016, VMFS 216 determines whether the decompressed data of step 1006 is compressible according to a different compression type other than the substream compression type. If so, then at step 1018, VMFS 216 compresses and stores the decompressed data according to the different compression type, such as the block compression type described above. If, however, the decompressed data of step 1006 is not compressible, then, at step 1020, VMFS 216 stores the decompressed data of step 1006 in an available block 306 and updates block reference 402 associated with the write request.

In one embodiment, each file inode 310 specifies a journaling region within file system 115 that can be used for documenting any IO operations that are performed on the corresponding file. The journaling region can also be used to store data associated with a file for back-up purposes while the file is being updated. More specifically, before performing a write operation on a specific block 306 or a specific sub-block 308 that stores data associated with a file, file inode 310 corresponding to the file is first read to determine the journaling region associated with the file. The data currently stored within the specific block 306 or the specific sub-block 308 is then written to the journaling region as a back-up. The write operation is then performed on the specific block 306 or the specific sub-block 308. If, for any reason, the write operation fails or does not complete properly, the data stored in the journaling region can be restored to the specific block 306 or the specific block 308.

Although the inventive concepts disclosed herein have been described with reference to specific implementations, many other variations are possible. For example, the inventive techniques and systems described herein may be used in both a hosted and a non-hosted virtualized computer system, regardless of the degree of virtualization, and in which the virtual machine(s) have any number of physical and/or logical virtualized processors. In addition, the invention may also be implemented directly in a computer's primary operating system, both where the operating system is designed to support virtual machines and where it is not. Moreover, the invention may even be implemented wholly or partially in hardware, for example in processor architectures intended to provide hardware support for virtual machines. Further, the inventive system may be implemented with the substitution of different data structures and data types, and resource reservation technologies other than the SCSI protocol. Also, numerous programming techniques utilizing various data structures and memory configurations may be utilized to achieve the results of the inventive system described herein. For example, the tables, record structures and objects may all be implemented in different configurations, redundant, distributed, etc., while still achieving the same results.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments, may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

What is claimed is:

1. A method of storing compressed data within a file system, comprising:
identifying a first block of data within the file system that should be compressed;
compressing the first block of data according to a first compression type;
allocating a first sub-block within the file system for storing the compressed first block of data; and
storing the compressed first block of data within the first sub-block,
wherein the first block of data is associated with a file, and a reference to the first block of data is stored within a file descriptor of the file and a size of the first sub-block is smaller than a size of the first block.

2. The method of claim 1, further comprising the step of determining that the first block of data can be compressed according to the first compression type.

3. The method of claim 2, wherein the first block of data can be compressed according to the first compression type when the first block of data, when compressed, fits into the first sub-block.

4. The method of claim 1, wherein the file descriptor is an inode associated with the file.

5. The method of claim 4, further comprising:
after storing the compressed first block of data within the first sub-block, updating the inode to remove the reference to the first block of data from the inode and to insert a reference to the first sub-block into the inode as well as a compression bit indicating the first compression type.

6. The method of claim 1, wherein the first block of data is identified based on a frequency of input/output operations performed on the first block of data.

7. The method of claim 1, wherein the first block of data is identified based on an average size of input/output operations performed on the first block of data.

8. The method of claim 1, further comprising:
receiving an input/output operation associated with the first sub-block;
decompressing data stored within the first sub-block; and
performing the input/output operation on the decompressed data.

9. The method of claim 8, wherein the input/output operation is a store operation that comprises:
patching the decompressed data with data associated with the store operation;
compressing the patched decompressed data; and
storing the patched decompressed data into the first sub-block.

10. A method of compressing a block of data within a file system, comprising:
dividing a first block of data into a plurality of sub streams;
compressing each substream included in the plurality of substreams; and
storing each compressed substream in a different portion of a first sub-block.

11. The method of claim 10, further comprising:
determining that the each substream, when compressed, fits into a fixed size portion of the first sub-block.

12. The method of claim 11, further comprising:
padding each compressed substream such that the compressed substream, when padded, fills the fixed size portion of the first sub-block.

13. The method of claim 10, further comprising:
generating a dictionary that stores a start offset for each compressed substream stored within the first sub-block.

14. The method of claim 10, further comprising:
receiving an input/output operation associated with the first sub-block;
based on an address associated with the input/output operation, identifying a first substream within the first sub-block that stores data associated with the input/output operation;
decompressing the data stored within the first substream; and
performing the input/output operation on the decompressed data.

15. The method of claim 14, further comprising:
after performing the input/output operation, recompressing the decompressed data.

16. The method of claim 15, further comprising:
determining whether the recompressed data fits in the first substream.

17. The method of claim 16, further comprising:
storing the recompressed data in the first substream when the recompressed data fits in the first substream.

18. The method of claim 16, further comprising:
compressing data stored in each substream within the first sub-block according to a different compression type.

19. A file inode associated with a file of a file system, comprising:
one or more file attributes;
a set of block references, wherein each block reference is associated with a different block within a data storage unit (DSU) that stores a portion of the file; and
a set of sub-block references, wherein each sub-block reference is associated with a different sub-block within the DSU that stores a portion of the file.

20. The file inode of claim 19, wherein the file inode further comprises:
a compression attribute that is stored with each sub-block reference,
wherein the compression attribute indicates the type of compression performed on data stored within the sub-block.

21. The file inode of claim 19, wherein the one or more file attributes include a first attribute indicating a first fixed size of each block associated with the set of block references.

22. The file inode of claim 21, wherein the one or more file attributes include a second attribute indicating a second fixed size of each sub-block associated with the set of sub-block references.

23. The file inode of claim 22, wherein the first fixed size is larger than the second fixed size.
